(19) United States
(12) Patent Application Publication
(10) Pub. No.: US 2002/0026580 A1
(43) Pub. Date: Feb. 28, 2002

(54) System for access control to hidden storage area in a disk drive

(76) Inventor: Fubito Igari, Hamura-shi (JP)

Correspondence Address: Finnegan, Henderson, Farabow, Garrett & Dunner, L.L.P., 1300 I Street, N.W., Washington, DC, 20005-3315, US

(21) Appl. No.: 09/907,636

(22) Filed: Jul. 19, 2001

(30) Foreign Application Priority Data
Jul. 19, 2000 (JP) 2000-219442

(51) Int. Cl. H04L 9/00

(52) U.S. Cl. 713/168

(57) ABSTRACT

A disk drive capable of setting a hidden area in which the access thereto is limited, on a disk is disclosed. The disk drive sets a predetermined storage area on the disk as a hidden area in accordance with a setting command from a host system. In accordance with this setting processing, the disk drive informs the host system of a capacity of a normal storage area comprising all storage areas on the disk except for the hidden area. Further, the disk drive cancels the hidden area on the disk and changes it to the normal storage area in accordance with a canceling command from the host system. In accordance with this canceling command, the disk drive erases the data, which is recorded in the hidden area on the disk.

### CROSS-REFERENCE TO RELATED APPLICATIONS

This application is based upon and claims the benefit of priority from the prior Japanese Patent Application No. 2000-219442, filed Jul. 19, 2000, the entire contents of which are incorporated herein by reference.

### BACKGROUND OF THE INVENTION

1. Field of the Invention

The present invention generally relates to a disk storage drive. Particularly, the present invention relates to a disk drive having a function capable of limiting the access to a specific storage area on the disk.

2. Description of the Related Art

In recent years, information service systems have become popular in order to distribute contents data such as images (moving images and static images), voice or the like, or a program from the Internet or digital broadcast network. In such a system, data to be distributed is downloaded into a digital device including a personal computer or the like so as to be stored in a storage device, which is attached to the device. The digital device includes a digital television set and a mobile information device such as a portable phone or an exclusive reproducing device or the like.

A storage device attached to these devices may comprise a memory card consisting of a flash EEPROM or the like and a disk drive having a recording medium consisting of a magnetic disk or an optical disk.

In an information service system, particularly, a security function for preventing copying is necessary and indispensable in order to protect the copy right of contents data and a program. As a method for realizing this security function, there is a system which sets a specific storage area of a recording medium as a hidden storage area, in which the access thereto is limited.

For example, security information necessary for an authorization function is stored in a hidden storage area. The security information is required to activate a program for decoding data in which distribution data such as contents or the like is encrypted. Alternatively, the distribution data such as contents or the like (encrypted data) is stored in a normal storage area (a storage area capable of unlimited access) of the recording medium. Specifically, the security information includes unique ID information in a medium as a recording medium, or a password information or the like.

Conventionally, various security functions have been developed, for example, with respect to a system for use with a memory card consisting of a flash EEPROM. On the contrary, in a system for use of a disk drive represented by a hard disk drive, various security functions are realized with respect to a host system (a body of a digital device). However, an effective security function is not realized in the drive itself because of the following reasons.

First, a function is provided in the disk drive to inform a host system of all storage capacities of the disk and the upper limit of a storage capacity of a normal storage area (a user area) capable of using an application program in all storage areas on the disk. Therefore, in the case that a predetermined storage area of the disk is set as a hidden area in which the access thereto is limited, the hidden area is excluded from a normal storage area. Accordingly, from the application program side (user), there occurs a situation such that the upper limit storage capacity of a normal storage area, which is informed from the drive, and the upper limit of a storage capacity on the disk capable of being used actually do not match. Therefore, in the case that the hidden area is set, there is a problem such that compatibility of the disk drive is not capable of being secured between an application program capable of accessing the hidden area and the application program for accessing only a normal storage area. Particularly, the application program for accessing only a normal storage area cannot access the hidden area when it recognizes that the upper limit of the available storage capacity includes the hidden area, so that a possibility such that a defect such as an access error or the like occurs is increased.

Second, in the case of canceling the setting of the hidden area from the disk, a storage area corresponding to the hidden area is changed to a normal storage area. In accordance with this, the access limitation is canceled in the storage area corresponding to the hidden area, so that it is possible to access this storage area unconditionally. Accordingly, in the case that the security information is stored in the hidden area, there is a possibility that the security information is accessed and encrypted contents data is decoded. Namely, this means invalidation of a copy preventing function. Particularly, in the case that the disk drive is a card type capable of being exchanged and a host system is changed, such a situation is subject to occur.

### BRIEF SUMMARY OF THE INVENTION

A first object of the present invention is to provide a disk drive capable of setting a hidden area in which the access thereto is limited, on a disk and capable of preventing the occurrence of a defect such as an access error or the like in advance by securing compatibility to an application program for accessing only a normal storage area.

A second object of the present invention is to provide a disk drive capable of preventing copying of data which is stored in the hidden area which is set on the disk.

A first aspect of the present invention is a disk drive comprising an access controller for setting a hidden area on a disk in accordance with a setting command from a host system and carrying out an access control for allowing the access to the hidden area only in the case that a predetermined access condition is satisfied; and a format controller for informing the host system of a storage capacity comprising the upper limit of a storage capacity on the disk except for a storage capacity corresponding to the hidden area as a normal storage capacity in the case that the hidden area is set and informing the host system of a normal storage capacity including a storage capacity corresponding to the hidden area in the case that the setting of the hidden area is canceled in accordance with the canceling command.

In other words, the disk drive according to the present invention sets the hidden area, in which the access thereto is limited, in a storage area on the disk in accordance with a setting command from the host system. The corresponding hidden area is controlled so that, for example, only a specific application which is authorized by the authentication processing, is capable of accessing thereto. Therefore, an unauthorized normal application program is not capable of copying the data in the hidden area, for example, when the unauthorized normal application program intends to copy the data in all storage areas of the disk drive. Therefore, it is possible to assure security of the data which is stored in the hidden area.

Further, the disk drive according to the present invention informs the host system of a capacity of a storage area except for the hidden area as a normal storage capacity in the case that the hidden area is set. As a result, the host system is informed of a storage capacity except for the hidden area as the upper limit storage capacity on the disk upon executing a normal application program. Therefore, it is possible to secure compatibility between different application programs independently of the security function in the same disk drive.

A second aspect of the present invention is the disk drive further comprising a cancel controller for canceling a setting of the hidden area in accordance with the canceling command from the host system and erasing the information which is recorded in the hidden area.

In other words, the disk drive according to the present invention is capable of setting a storage area on the disk as a hidden area, in which the access thereto is limited, and a normal storage area capable of being normally accessed in accordance with a command from the host system as well as arbitrarily canceling the setting of the hidden area. Further, the disk drive erases data which is stored in the hidden area, in the case of canceling the setting of the hidden area in accordance with a canceling command from the host system.

According to such a configuration, it is possible to erase data in relation to the security which is stored in the hidden area, upon canceling the hidden area. Therefore, it is possible to prevent a situation such that the data stored in the hidden area is carelessly leaked out to the outside by a normal application program, even in the case the storage area, in which the setting of the hidden area is canceled, is accessed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a block diagram for illustrating essential parts of a disk drive according to an embodiment of the present invention;

FIGS. 2A and 2B are diagrams for explaining a setting method for a hidden area according to the embodiment of the present invention;

FIGS. 3A and 3B are diagrams for explaining a concrete example of a setting position of a hidden area according to the embodiment of the present invention;

FIG. 4 is a flow chart for explaining a procedure for setting and canceling a hidden area according to the embodiment of the present invention;

FIG. 5 is a flow chart for explaining a procedure of controlling an access to a hidden area according to the embodiment of the present invention;

FIGS. 6A and 6B are diagrams for illustrating an example of a reading command of a drive ID information according to the embodiment of the present invention; and

FIGS. 7A and 7B diagrams for illustrating an example of a setting command and a canceling command of a hidden area according to the embodiment of the present invention.

### DETAILED DESCRIPTION OF THE INVENTION

An embodiment of the present invention will be explained with reference to the drawings below.

(A Configuration of a Disk Drive)

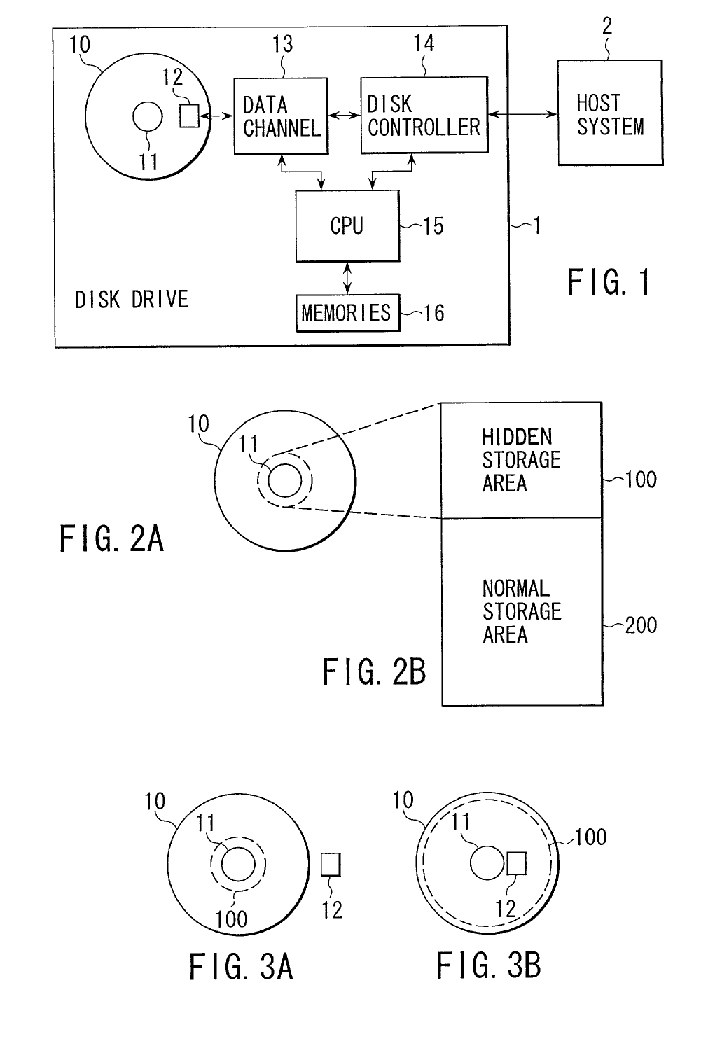

FIG. 1 illustrates essential parts of a disk drive 1 according to the present embodiment. As the disk drive 1 of the present embodiment, for example, a card type hard disk drive is assumed. As a host system 2, a computer of a digital device for use of the disk drive 1 as a detachable storage device is assumed. The disk drive 1 carries out various operations in association with a command from the host system 2.

The host system 2 has a microprocessor and various application software as main elements. For example, the host system 2 is connected to the Internet and a digital broadcasting network and downloads contents data and programs which are distributed from the network in the disk drive 1. Further, the host system 2 is provided with a security function such as a decoding function and a copy preventing function of the distributed data (encrypted data) which is downloaded.

The disk drive 1 comprises a disk 10 as a data recording medium, a head 12 for recording or reproducing the data, a data channel 13, a disk controller 14, a CPU 15 and memories 16 including various IC memories.

The disk 10 is controlled by the CPU 15 so as to be rotated at high speed by a spindle motor 11 upon recording or reproducing the data. The head 12 is configured capable of moving in a radius direction of the disk 10 by a head actuator (not illustrated) on the basis of the control of the CPU 15. The data channel 13 comprises a read/write signal processing circuit for performing a signal processing to convert a lead signal from the head 12 into reproduction data and convert recording data from the disk controller 14 to a recording signal.

The disk controller 14 configures an Interface (for example, an ATA interface specification) of the disk drive 1 and the host system 2 and controls the transference of various commands and the data from the host system 2. The CPU 15 is a main control element of the drive 1 and performs the control in relation to setting and canceling the hidden area according to the present embodiment in addition to the operation for recording and reproducing the data and the control for a head positioning or the like. Alternatively, the CPU 15 performs the access control (including the authentication processing) with respect to the hidden area. The memories 16 comprise a RAM and a ROM for storing the program and the control data and a nonvolatile flash memory

(Setting of the Hidden Area)

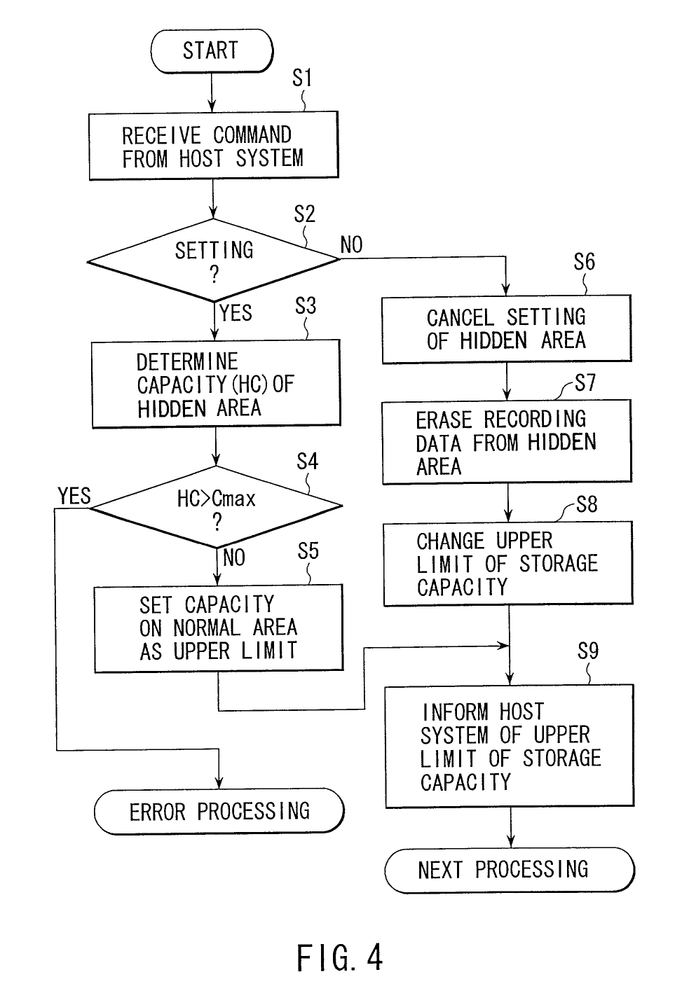

The operation of the present embodiment will be explained mainly with reference to a flow chart in FIG. 4 below.

The disk drive 1 receives and decrypts a command to be transmitted from the host system 2 by the disk controller 14 and carries out various operations in accordance with contents of the command (step S1). In the case that the command from the host system 2 is a setting command of the hidden area, the CPU 15 of the disk drive 1 carries out a setting procedure of the hidden area (YES of step S2).

The CPU 15 sets a storage area having a storage capacity which is designated by the setting command from all storage areas (here, one section of a disk is assumed) on the disk 10 as a hidden storage area 100 (refer to FIG. 2B). In this case, the CPU 15 sets the hidden storage area 100, for example, in a predetermined inner periphery area on the disk 10 as shown in FIG. 2A.

The set hidden area 100 comprises a storage area in which the access thereto is limited. Only an application program (user) satisfying a predetermined access condition is capable of accessing the set hidden area 100. As described later, the CPU 15 carries out the authentication processing, so that it carries out the access control such that only an authorized application program (user) is capable of accessing the hidden area. The CPU 15 records the information necessary for the authentication processing (information in relation to security) on the disk 10 or the flash memory included in the memories 16.

In this case, the storage area except for the hidden area 100 in all the storage areas on the disk 10 is distinguished as a normal storage area 200. The hidden area 100 comprises a storage area in which only a specific application program satisfying a predetermined access condition is capable of accessing. On the contrary, the normal storage area 200 comprises a storage area which the normal application program independent of the security function is capable of accessing.

Next, the CPU 15 compares a capacity (HC) of the hidden area 100 which is set by the host system 2 with the total storage capacity (Cmax) of the disk 10, so that the CPU 15 determines whether it is possible to ensure the capacity of the hidden area 100 (step S4). In the case that the capacity of the hidden area 100 exceeds the total storage capacity according to this determination result, the CPU 15 carries out a predetermined error processing (YES of step S4). Accordingly, the setting command of the hidden area 100 from the host system 2 is invalid. Alternatively, depending on a storage capacity of the disk 10 at the present time, also if there is a situation such that the capacity of the hidden area 100 is not capable of being secured, the error processing is also carried out.

As described above, the CPU 15 sets a predetermined storage area (inner periphery area) on the disk 10 as the hidden area 100 when it is possible to secure the capacity of the hidden area 100. Next, the CPU 15 sets the capacity of the normal storage area 200 comprising the storage area except for the hidden area 100 in all the storage areas on the disk 10 as the upper limit capacity of the disk 10 (step S5). Then, the CPU 15 informs the host system 2 of the upper limit capacity corresponding to the capacity of the normal storage area 200, which is set through the disk controller 14. Accordingly, the host system 2 recognizes that the upper limit capacity in the case of accessing the disk 10 is a capacity of the normal storage area 200 (refer to FIG. 2B). In other words, the normal application program does not access the hidden area 100 having a capacity over the upper limit capacity. Alternatively, the normal storage area 200 except for the hidden area 100 is managed by a FAT (file allocation table) to be recorded on the disk 10. Additionally, the CPU 15 records the address information necessary for controlling the access of the hidden area 100 and the information necessary for an authentication processing (information in relation to security) on the disk 10 or the flash memory included in the memories 16.

Alternatively, the hidden area 100 is set on the inner periphery area on the disk 10 as shown in FIG. 3A when the disk drive 1 is a ramp loading type. According to the ramp loading type, the head 12 is configured so as to be removed to the outside of the disk 10 when the drive 1 is not operated. Accordingly, it is desirable for the ramp loading type to set the hidden area 100 in the inner periphery area since the outer periphery area of the disk 10 has a higher chance of being damaged by contact with the head 12 or the like.

On the other hand, in the case that the disk drive 1 is a CSS type (contact start and stop type), the hidden area 100 is set in the outer periphery area as shown in FIG. 3B. In the CSS type, the head 12 is configured to be removed to a CSS area in the inner periphery side of the disk 10 when the drive 1 is not operated. Accordingly, it is desirable for the CSS type to set the hidden area 100 in the outer periphery area since the inner periphery area of the disk 10 has a higher chance of being damaged by contact with the head 12 or the like.

In this case, according to a concrete example of a setting command of the hidden area from the host system 2, for example, a lower limit address of the hidden area is set as shown in FIG. 7A. According to this command, a cylinder number is designated as a lower limit address of the hidden area and a head number is fixed at 0 and a sector number is fixed at 1. It is assumed that the area from the lower limit address which is designated this command, to the upper limit area which the user is capable of using for storage in the drive 1, is set as a hidden area.

For example, when the drive 1 is configured such that the number of the cylinders is 3900, the number of the heads is 16 and the number of the sectors per track is 63, it is assumed that the hidden area 100 is secured from the cylinder number 3600. Namely, as shown in FIG. 7A, 10h, i.e., a low order 1 byte of a numeric value (0E10h) in the case that 3600 is represented by hexadecimal is set with respect to a cylinder low register. Further, 0Eh, i.e., a high order 1 byte is set with respect to a cylinder high register and a command is issued. Alternatively, it is assumed that arbitrary information is set to a sector number as password information.

Here, a storage capacity of the normal storage area 200 except for the hidden area 100 is calculated. Since the lower limit address is set, the upper limit cylinder number in the no-hidden area is 3599 in this setting. Since the cylinder number is commenced from 0, the number of the cylinders becomes 3600. This is multiplied by the number of the heads and the number of the sectors per track.

Alternatively, in the case that the drive 1 is in an IDE interface specification, it is general that the number of the cylinders, the number of the heads and the number of the sectors per track, which are shown in the host system 2, are not identical with those of the configuration of the recording medium. For example, as the CDR type, the number of the sectors per track is different for every waiting zone in a plurality of zones. However, according to the IDE interface specification, the number of the sectors per track is equal in all tracks, so that the conversion is logically performed. Specifically, the host system 2 sets the number of the sectors and the number of the heads per virtual track in the disk drive 1. Then, the disk drive 1 calculates the number of the cylinders on the basis of these numerical values to indicate the logical number of the cylinders to the host system 2. The number of the heads and the number of the sectors per track are identical with the number of the heads and the number of the sectors per this virtual track.

(Canceling of the Hidden Area)

In the case that the command from the host system 2 is a canceling command of a hidden area, the CPU 15 of the disk drive 1 carries out the canceling procedure of the hidden area as follows (NO in step S2).

The CPU 15 cancels the hidden area 100 which is set on the disk 10, and changes it to the normal storage area 200 (step S6). In this case, the CPU 15 erases all the data which are recorded in the hidden area 100 to be canceled (step S7). Further, the CPU 15 resets the upper limit capacity of the normal storage area 200 to which the storage area corresponding to the hidden area 100 is added in connection with the cancel of the hidden area 100 (step S8). The CPU 15 informs the upper limit capacity of the changed normal storage area 200 through the disk controller 14 (step S9). Accordingly, the host system 2 recognizes a capacity of the changed normal storage area 200 as the upper limit capacity for accessing the disk 10 in connection with the execution of the application.

A concrete example of a method for canceling the hidden area is as follows.

For example, the canceling command of the hidden area from the host system 2 is configured as shown in FIG. 7B. Namely, the CPU 15 compares the lower limit cylinder number which is designated by the above hidden area setting command with the password information. Then, if they do not coincide, the CPU 15 does not cancel the hidden area. Alternatively, the CPU 15 substantially erases the data which is recorded in the hidden area, by writing the information, which is determined in advance, in all the hidden area or in a part of the hidden area (for example, writing 00h in all the area) when canceling the hidden area.

As described above, according to the present embodiment, in the case that the hidden area in which the access thereto is limited is set on the disk, the host system 2 is informed of only the normal storage area 200 comprising all the storage areas except for the hidden area 100 as the area capable of storing. Accordingly, the normal application program is capable of preventing in advance the occurrence of the access error such as the access over the upper limit capacity, since it is informed of a storage capacity comprising all the storage areas except for the hidden area 100 as the upper limit normal storage area on the disk 10. On the other hand, the specific application program accesses the hidden area 100 depending on a predetermined access condition. Therefore, even in the case that the hidden area 100 is set in the same disk drive, it is possible to secure compatibility between different application programs.

On the other hand, when the hidden area 100 is canceled, the CPU 15 erases the data stored in the hidden area 100. Therefore, even in the case that the storage area corresponding to the original hidden area 100 which is changed to the normal storage area 200 is accessed, it is possible to prevent a situation such that the data stored in the hidden area 100 is leaked out. As a result, it is possible to prevent a situation in advance such that the information to be secured is carelessly accessed upon canceling the hidden area 100 and a copy preventing function of the contents data which is recorded on the disk 10 is invalid.

Alternatively, the hidden area is set on the area, which is relatively hardly damaged on the disk. Specifically, in the CSS type, the hidden area is set on the relatively outer periphery side. On the contrary, in the ramp load type, the hidden area is set on the relatively inner periphery side. In other words, a position where the hidden area is set is determined by the removal position of the head when the drive 1 is not operated. Accordingly, it is possible to surely protect the information recorded in the hidden area, for example, the information in relation to the security functions.

(A Utilization Example of the Hidden Area)

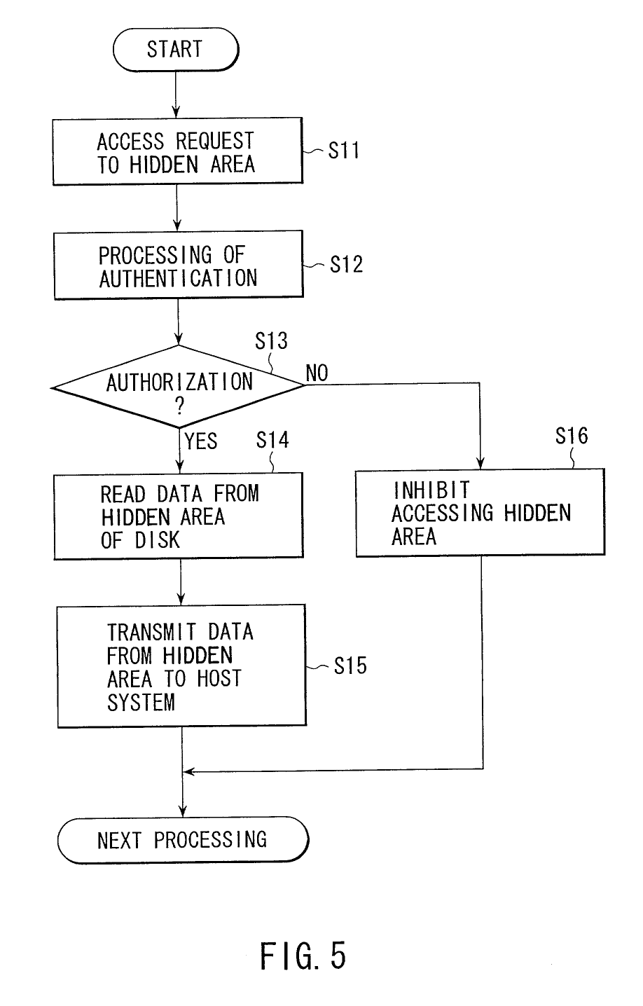

A concrete example in the case of using the hidden area will be explained mainly with reference to a flow chart in FIG. 5.

For example, the host system 2 downloads the contents data which is distributed through the Internet to store the contents data in the normal storage area 200 on the disk 10. The corresponding contents data is encrypted data, so that this contents data is not capable of being used as it is. Therefore, the host system 2 stores the information for decoding the contents data (disk key information) in the hidden area 100 which is set on the disk 10.

Assuming such a situation, a procedure such that the specific application program of the host system 2 accesses the hidden area 100 will be explained.

At first, if there is an access request from the host system 2 to the hidden area 100, the CPU 15 of the disk drive carries out a predetermined authentication processing (step S11, S12). In this case, for example, the CPU 15 carries out so called challenge response type of authentication processing to allow only one access by one authentication processing.

The CPU 15 inhibits the normal application program (user), which is not capable of being authorized by the authentication processing, from accessing the hidden area 100 on the disk 10 (NO of step S13, step S16). Alternatively, the application program is capable of accessing the contents data stored in the normal storage area 200. However, since the application program is the encrypted data, it is not capable of being used as it is.

On the other hand, the CPU 15 accesses the hidden area 100 on the disk 10 and reads out the information stored in the hidden area 100 when it authorizes the specific application program (YES of step S13, step S14). The CPU 15 transfers the information which is read out from the hidden area 100, to the host system 2 through the disk controller 14 (step S15). Therefore, in the host system 2, the specific application program carries out the processing for decoding the contents data (the encrypted data), which is stored in the normal storage area 200, by using the information stored in the hidden area 100 (the disk key information).

As described above, only the specific application program is capable of decoding the contents data stored in the normal storage area 200 to use it by storing the information for decoding the encrypted data (the security information) which is stored in the normal storage area 200, in the hidden area 100 in which the access thereto is limited. In this case, the authentication processing is performed so that only the specific application program is capable of accessing the hidden area 100. Although the normal application program can access the contents data stored in the normal storage area 200, the normal application program is not capable of accessing the hidden area 100. Therefore, the normal application program is not capable of decoding the contents data to use it. In other words, the disk drive 1 according to the present embodiment is capable of realizing the security function of the contents data which is stored in the normal storage area 200, by the setting function and the authorization function of the hidden area 100.

Alternatively, since the information stored in the hidden area 100 (the security information) is erased by the above canceling function of the hidden area 100, it is possible to maintain the security function of the contents data, which is stored in the normal storage area 200. This canceling function is particularly effective, for example, when the disk drive 1 is a card type drive and is capable of being exchanged. Namely, when the disk drive 1 is shifted from one host system to another host system after the hidden area 100 is canceled, it is possible to prevent in advance a situation such that the security information is leaked out from the hidden area 100 (normally, it is changed to the normal storage area 200) by another host system.

The authentication processing of the disk drive 1 (step S12) will be specifically explained below.

The host system 2 receives different information for every authentication processing (the drive ID information) from the disk drive 1 if the hidden area 100 is requested to be accessed. The disk drive 1 carries out the encryption processing using random numbers which are generated for every authentication processing, to generate the information different for every authentication processing. The host system 2 carries out the arithmetic operation for the use of the key information and the encrypted information by using a preset function to send back the arithmetic operation result as the response information to the disk drive 1.

The disk drive 1 calculates the arithmetic operation result obtained by calculating the key information and the encrypted information by using the same function to compare it with the response information. If they coincide, the disk drive 1 allows the host system 2 access. In response to this access allowance by the authentication processing, the disk drive 1 accesses the information stored in the hidden area 100 (the disk key information) to transfer this information to the host system 2. In this case, the disk drive 1 encrypts the information stored in the hidden area 100 by the encryption function due to the random number which is used in the authentication processing, to transfer the encrypted information to the host system 2. The host system 2 decodes it by the function and the key information to obtain the disk key information. Then, the host system 2 uses the disk key information to decode the encrypted distributed data (the contents data) which is accessed from the normal storage area 200.

According to such an authorization function, the information different for every authentication processing (the drive ID information and the response information) are exchanged between the host system 1 and the disk drive 1. Accordingly, only one access is allowed every for authentication processing, so that the access to the hidden area 100 is capable of being limited.

Further, in the case that the access is allowed by the authentication processing, by using the encryption function in the authentication processing, the information stored in the hidden area 100 is encrypted to be transferred to the host system. In other words, on the interface (the connection signal line) of the host system 2 and the disk drive 1, the information stored in the hidden area 100 is not transferred as it is but is transferred as the encrypted data. Additionally, the information stored in the hidden area 100 is transferred as the different encrypted data every for authentication processing in response to the access request. Accordingly, it is possible to certainly prevent a situation such that the information accessed from the hidden area 100 flows as it is, for example, through the network connected to the host system 2 or the like. In other words, the host system 2 and the disk drive 1 can have the same disk key information without exchanging the information therebetween, so that it is possible to inhibit a situation such that the disk key information is accessed from the outside.

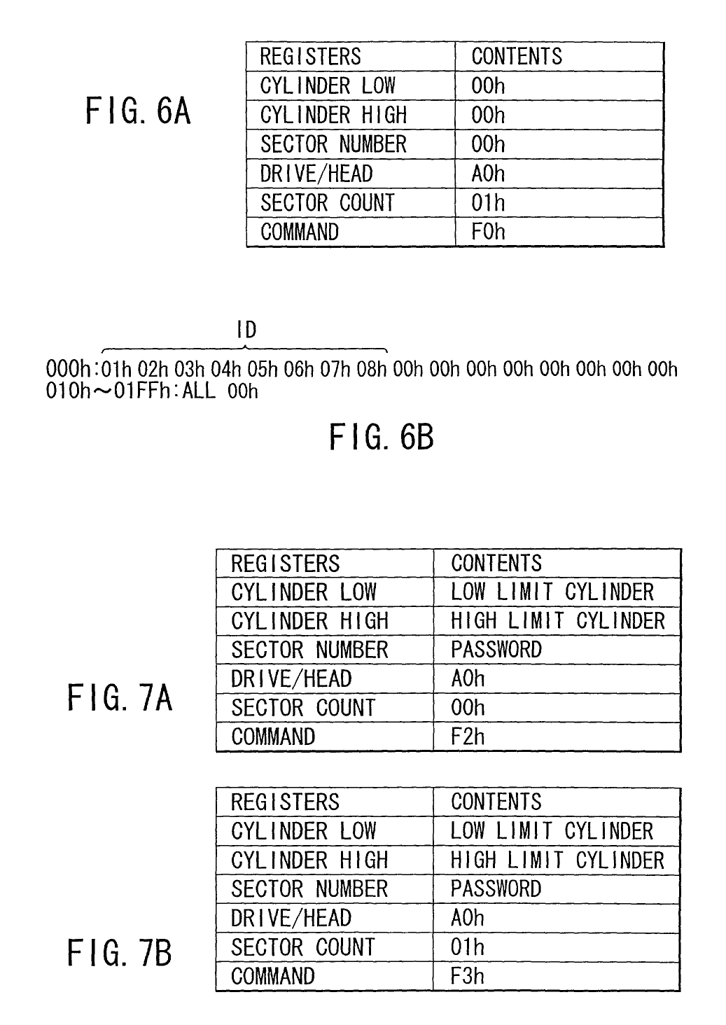

Alternatively, for example, in the case of the disk drive 1 having an IDE interface, the host system 2 issues a reading command as shown in FIG. 6A to read out the drive ID information from the disk drive 1. The transfer data in connection with this command processing is configured as shown in FIG. 6B. In other words, in this case, the transfer data is 512 bytes and the drive ID information is disposed in the area of 8 bytes from a head of the transfer data. Accordingly, according to the present embodiment, the drive ID information is considered to be 0102030405060708h.

Alternatively, from the point of view of a mechanism for preventing the inner information from being read out by the analysis of the drive, it is preferable that the storage area of the information indicating that the hidden area is provided is set on the disk. That is why it is possible to access the information in the hidden area when a print substrate is exchanged if the information is stored in the flash FEPROM on the print substrate, on which the IC group of the disk drive is arranged. According to other method, storing the information that is determined to be different for every drive or statistically determined to be different for every drive in the disk and the memory on the print substrate, if these information items do not coincide, the access to the data on the disk is not performed.

Additionally, there is a method for setting the information for managing the contents data in the hidden area as a function to prevent the information in the hidden area from being lost by the failure of the disk drive 1. The information for managing the contents data includes an encryption key for reproducing the contents data. The user purchases the encryption key as well as the contents data, so that the encryption key is stored in the hidden area. In the case that the disk drive gets out of order, it is not possible to read out the contents data. However, when the user is provided with the encryption key information in the hidden area, for example, from the Internet again, the user is capable of reproducing the purchased contents data.

As described in detail above, first, in the case that the hidden area, which only the specific application program is capable of accessing, is set on the disk, the normal application program can recognize the normal storage area except for the hidden area as a range which the normal application program can access. Therefore, it is possible to prevent in advance a situation such that a failure such as an access error occurs when the normal application program accesses the storage area including the capacity of the hidden area. Second, in the case of canceling the hidden area, the data stored in the hidden area is erased. Accordingly, even when the hidden area is changed to a normal storage area and the normal application program is capable of accessing it, it is possible to prevent in advance a situation such that the data stored in the hidden area is leaked out. Therefore, it is possible to maintain the security function when realizing the security information for protecting the information stored in a normal storage area by the data stored in the hidden area.

Additionally, third, by using a method for allowing only one access by one authentication processing (for example, a function of authentication referred to as a challenge response type) as an authentication processing necessary for accessing the hidden area, for example, it is possible to limit the number of accesses to the information stored in the hidden area. As a result, it is possible to decrease a possibility such that a situation of the unlawful access to the hidden area occurs. Further, according to a method of the authentication processing of the present embodiment, in the case of exchanging the information necessary for the authentication processing, the encryption function is used to encrypt the information. Specifically, in the case that the access from the host system to the hidden area is allowed, by using the encryption function in the authentication processing, the information stored in the hidden area is encrypted to be transferred to the host system. According to such an authentication processing, the information stored in the hidden area is not transferred as it is but it is transferred as the encrypted data in the interface between the host system and the disk drive. Accordingly, it is possible to prevent a situation such that the information accessed from the hidden area is unlawfully accessed as it is through, for example, the network connected to the host system.

According to an application of the present invention, a disk drive capable of being exchanged for every drive, for example, a card type disk drive is effective. The disk drive is provided with a large storage area differently from a memory card consisting of an IC memory. It is possible to arbitrarily set a hidden area and a normal storage area in this large storage area. At the same time, it is possible to cancel the hidden area and change it to a normal storage area. According to a concrete example, in the host system in which the disk drive of the present invention is set, for example, in the case that the specific application program for performing the reproducing processing of the encrypted music data is carried out, the hidden area which is capable of accessing only the specific application program is set on the disk. In the normal storage area on the disk, the encrypted music data is stored. In the hidden area, the key information for decoding the encrypted data is stored. The specific application program obtains the key information by accessing the hidden area and decodes the encrypted data so as to reproduce the music data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive having a system for reading or writing data to be accessed by a host system in a disk, said disk drive comprising:
a host interface for receiving a setting command to set a predetermined storage area on said disk as a hidden area in which the access thereto is limited, or a canceling command for canceling the setting of said hidden area in accordance with a predetermined command to be transmitted from said host system;
an access controller for setting said hidden area on said disk in accordance with said setting command and carrying out an access control for allowing an access to said hidden area only in the case that a predetermined access condition is satisfied; and
a format controller for informing said host system of a storage capacity comprising the upper limit storage capacity on said disk except for a storage capacity corresponding to said hidden area as a normal storage capacity in the case that said hidden area is set and informing said host system of a normal storage capacity including a storage capacity corresponding to said hidden area in the case that a setting of said hidden area is canceled in accordance with said canceling command.

2. The disk drive according to claim 1, further comprising a cancel controller for canceling a setting of said hidden area in accordance with said canceling command from said host system and erasing information which is recorded in said hidden area.

3. The disk drive according to claim 2, wherein said format controller informs said host system of a normal storage capacity including a storage capacity corresponding to said hidden area in the case that a setting of said hidden area is canceled by said cancel controller.

4. The disk drive according to claim 1, further comprising a command controller for invalidating said setting command in the case that it is not possible to secure said hidden area to be set in accordance with said setting command from said host system from the storage area on said disk.

5. The disk drive according to claim 1, wherein said access controller controls an access to said hidden area so as to be allowed only by a specific application program, which is authorized by a predetermined authentication processing.

6. The disk drive according to claim 5, wherein said access controller carries out a method for allowing only one access by one authentication processing as a method of said authentication processing.

7. The disk drive according to claim 1, wherein said access controller encrypts information accessed from said hidden area to transfer it to said host system in the case that an access to said hidden area is allowed.

8. The disk drive according to claim 1, wherein said access controller sets a storage area which is relatively separated from an evacuating position of a head for recording or reproducing data in the disk in a storage area on said disk as said hidden area.

9. A disk drive comprising:
a disk having a storage area for recording data;
a read and write mechanism for writing or reading out data in/from said storage area;
a disk controller for transmitting and receiving data or a command to and from a host system and receiving a setting command to set a predetermined storage area on said disk as a hidden area in which the access thereto is limited, from said host system; and
a CPU for setting said hidden area on said disk in accordance with said setting command, carrying out an access control for allowing an access to said hidden area only in the case that a predetermined access condition is satisfied and informing said host system of a storage capacity comprising the upper limit storage capacity on said disk except for a storage capacity corresponding to said hidden area as a normal storage capacity.

10. The disk drive according to claim 9, wherein, when said disk controller receives a canceling command to cancel a setting of said hidden area from said host system, said CPU cancels the setting of said hidden area in accordance with said canceling command and erases information recorded in said hidden area, further, informs said host system of a normal storage capacity including a storage capacity corresponding to said hidden area.

11. The disk drive according to claim 9, wherein said CPU controls an access to said hidden area so as to be allowed only by a specific application program which is authorized by a predetermined authentication processing.

12. A method of access control for a disk drive having a system for reading or writing data to be accessed by a host system, the method comprising the steps of:
setting a hidden area, which is capable of being accessed only by a predetermined access condition, on said disk in accordance with a setting command from said host system;
informing said host system of a capacity of a normal storage area comprising all the storage capacities on said disk except for a storage capacity corresponding to said hidden area; and
carrying out an authentication processing for determining whether said access is allowed or not in accordance with an access request to said hidden area from said host system and allowing said access when said access request is authorized by said authentication.

13. The method according to claim 12, comprising the steps of:
changing a storage area set as said hidden area to a normal storage area in accordance with a canceling command from said host system;
erasing data stored in said hidden area; and
informing said host system of a capacity of a normal storage area including a storage area corresponding to said hidden area.
